(19) United States
(12) Patent Application Publication
(10) Pub. No.: US 2023/0163293 A1
(43) Pub. Date: May 25, 2023

(54) POSITIVE ACTIVE MATERIAL FOR NONAQUEOUS ELECTROLYTE ENERGY STORAGE DEVICE, POSITIVE ELECTRODE FOR NONAQUEOUS ELECTROLYTE ENERGY STORAGE DEVICE, NONAQUEOUS ELECTROLYTE ENERGY STORAGE DEVICE, ENERGY STORAGE APPARATUS, METHOD FOR USING NONAQUEOUS ELECTROLYTE ENERGY STORAGE DEVICE, AND METHOD FOR MANUFACTURING NONAQUEOUS ELECTROLYTE ENERGY STORAGE DEVICE

(71) Applicant: GS Yuasa International Ltd., Kyoto-shi, Kyoto (JP)

(72) Inventors: Takenori TOYAMA, Kyoto (JP); Shinya OTANI, Kyoto (JP); Daisuke ENDO, Kyoto (JP)

(21) Appl. No.: 17/917,177

(22) PCT Filed: Mar. 23, 2021
(86) PCT No.: PCT/JP2021/011889

§ 371 Date: Oct. 5, 2022

(30) Foreign Application Priority Data
Apr. 7, 2020 (JP) 2020-069110

(51) Int. Cl. H01M 4/525; H01M 10/052; H01M 4/505

(52) U.S. Cl. CPC H01M 4/525; H01M 10/052; H01M 4/505; H01M 2004/028

(57) ABSTRACT

A positive active material for a nonaqueous electrolyte energy storage device according to one aspect of the present invention is a positive active material for a nonaqueous electrolyte energy storage device containing a lithium transition metal composite oxide having an α-NaFeO₂ structure, the positive active material further containing aluminum, in which the lithium transition metal composite oxide contains at least one of nickel and cobalt, and manganese, a content of manganese in a transition metal. in the lithium transition metal composite oxide is 0.6 or less in terms of molar ratio, and in a charged state at a potential of 4.35 V vs. Li/Li⁺ in a state where there is no charge history in which the potential reaches 4.5 V vs. Li/Li⁺ or more, an oxygen positional parameter of the positive active material determined from crystal structure analysis by a Rietveld method when a space group R3-m is used. for a crystal structure model based on an X-ray diffraction pattern is 0.265 or more and 0.269 or less.

### TECHNICAL FIELD

The present invention relates to a positive active material for a nonaqueous electrolyte energy storage device, a positive electrode for a nonaqueous electrolyte energy storage device, a nonaqueous electrolyte energy storage device, an energy storage apparatus, a method of using a nonaqueous electrolyte energy storage device, and a method of manufacturing a nonaqueous electrolyte energy storage device.

### BACKGROUND ART

Applications of a nonaqueous electrolyte energy storage device represented by a lithium secondary battery have been increasingly expanded in recent years, and development of various positive active materials has been required. Heretofore, a lithium transition metal composite oxide having an α-NaFeO₂-type crystal structure has been examined as a positive active material for a nonaqueous electrolyte energy storage device, and a nonaqueous electrolyte secondary battery using a so-called LiMeO₂-type active material represented by LiCoO₂ and LiNi_{⅓}Co_{⅓}Mn _{1/33}O₂ has been widely put to practical use. In the LiMeO₂-type active material, a molar ratio (Li/Me) of lithium to a transition metal constituting the lithium transition metal composite oxide is almost 1.

On the other hand, in recent years, among lithium transition metal composite oxides having an α-NaFeO₂-type crystal structure, a so-called lithium-excess-type active material of which the molar ratio (Li/Me) of lithium to the transition metal is more than 1 has been developed (Patent Documents 1 and 2). A nonaqueous electrolyte energy storage device using such a lithium-excess-type active material attracts attention because the nonaqueous electrolyte energy storage device has a larger discharge capacity than the LiMeO₂-type active material.

Patent Document 1 describes a positive active material in which an oxide of Al is added to a particle surface of a lithium transition metal composite oxide. Patent Document 1 describes that an oxygen positional parameter of 0.267 or more is preferable as the oxygen positional parameter of the lithium transition metal composite oxide obtained by crystal structure analysis by a Rietveld method based on an X-ray diffraction pattern at a charge end after a constant current constant voltage charge history at a voltage of 4.6 V.

Patent Document 2 describes a positive active material including a composite oxide powder formed by mixing Co, Al-containing β-type nickel oxyhydroxide and lithium hydroxide monohydrate, subjecting a mixed powder to a heat, treatment, and then pulverizing the mixture. Patent Document 2 describes that an oxygen positional parameter of 0.2360 or more and 0.2420 or less is preferable as the oxygen positional parameter determined from crystal structure analysis of the composite oxide powder by the Rietveld method.

### PRIOR ART DOCUMENTS

### Patent Documents

Patent Document 1: JP-A-2016-167446

Patent Document 2: JP-A-2002-124261

### SUMMARY OF THE INVENTION

### Problems to be Solved by the Invention

In the nonaqueous electrolyte energy storage device, further improvement of a charge-discharge cycle capacity retention ratio and high rate discharge characteristics is required.

An object of the present invention is to provide a positive active material for a nonaqueous electrolyte energy storage device, a positive electrode for a nonaqueous electrolyte energy storage device, a nonaqueous electrolyte energy storage device, an energy storage apparatus, a method for using the nonaqueous electrolyte energy storage device, and a method for manufacturng the nonaqueous electrolyte energy storage device, which can enhance a charge-discharge cycle capacity retention ratio and high rate discharge characteristics.

### Means for Solving the Problems

One aspect of the present invention is a positive active material for a nonaqueous electrolyte energy storage device containing a lithium transition metal composite oxide having an α-NaFeO₂ structure, the positive active material further containing aluminum, and being a positive active material for a nonaqueous electrolyte energy storage device (A) in which the lithium transition metal composite oxide contains at least one of nickel and cobalt, and manganese, a content of manganese in a transition metal in the lithium transition metal composite oxide is 0.6 or less in terms of molar ratio, and in a charged state at a potential of 4.35 V vs. Li/Li⁺ in a state where there is no charge history in which the potential reaches 4.5 V vs. Li/Li⁺ or more, an oxygen positional parameter of the positive active material determined from crystal structure analysis by a Rietveld method when a space group R3-an is used for a crystal structure model based on an X-ray diffraction pattern is 0.265 or more and 0.269 or less.

Another aspect of the present invention is a positive active material for a nonaqueous electrolyte energy storage device containing a lithium transition metal composite oxide having an α-NaFeO₂ structure, the positive active material further containing aluminum, and being a positive active material for a nonaqueous electrolyte energy storage device (B) in which the lithium transition metal composite oxide contains at least one of nickel and cobalt, and manganese, and in a charged state at a potential of 4.35 V vs. Li/Li⁺ in a state where there is no charge history in which the potential reaches 4.5 V vs. Li/Li⁺ or more, an absolute value of a difference between an oxygen positional parameter of the positive active material determined from crystal structure analysis by a Rietveld method when a space group R3-m is used for a crystal structure model based on an X-ray diffraction pattern and an oxygen positional parameter of a positive active material, which contains no aluminum and has the same composition as the positive active material in terms of a molar ratio of a transition metal element contained, determined from the crystal structure analysis is 0.002 or less.

Another aspect of the present invention is a positive electrode for a nonaqueous electrolyte energy storage device, including either the positive active material (A) or the positive active material (B).

Another aspect of the present invention is a nonaqueous electrolyte energy storage device including the positive electrode for a nonaqueous electrolyte energy storage device.

Another aspect of the present invention is an energy storage apparatus including a plurality of nonaqueous electrolyte energy storage devices, and one or more of the nonaqueous electrolyte energy storage devices.

Another aspect of the present invention is a method for using a nonaqueous electrolyte energy storage device, the method including charging at a positive electrode potential in a range of less than 4.5 V vs. Li/Li⁺.

Another aspect of the present invention is a method for manufacturing a nonaqueous electrolyte energy storage device, the method including performing initial charge-discharge at a positive electrode potential in a range of less than 4.5 V vs. Li/Li⁺.

### Advantages of the Invention

According to one aspect of the present invention, it is possible to provide a positive active material for a nonaqueous electrolyte energy storage device, a positive electrode for a nonaqueous electrolyte energy storage device, a nonaqueous electrolyte energy storage device, an energy storage apparatus, a method for using the nonaqueous electrolyte energy storage device, and a method for manufacturing the nonaqueous electrolyte energy storage device, which can enhance a charge-discharge cycle capacity retention ratio and high rate discharge characteristics.

### BRIEF DESCRIPTION OF THE DRAWINGS

FIG. 1 is an external perspective view showing a nonaqueous electrolyte energy storage device according to one embodiment of the present invention.

FIG. 2 is a schematic diagram showing an energy storage apparatus including a plurality of the nonaqueous electrolyte energy storage devices according to one embodiment of the present invention.

### MODE FOR CARRYING OUT THE INVENTION

First, outlines of a positive active material for a nonaqueous electrolyte energy storage device, a positive electrode for a nonaqueous electrolyte energy storage device, a nonaqueous electrolyte energy storage device, an energy storage apparatus, a method for using the nonaqueous electrolyte energy storage device, and a method of manufacturing the nonaqueous electrolyte energy storage device disclosed in the present specification will be described.

A positive active material for a nonaqueous electrolyte energy storage device (A) according to one aspect of the present invention is a positive active material for a nonaqueous electrolyte energy storage device containing a lithium transition metal composite oxide having an α-NaFeO₂ structure, the positive active material (A) further containing aluminum, in which the lithium transition metal composite oxide contains at least one of nickel and cobalt, and manganese, a content of manganese in a transition metal in the lithium transition metal composite oxide is 0.6 or less in terms of molar ratio, and in a charged state at a potential of 4.35 V vs. Li/Li⁺ in a state where there is no charge history in which the potential reaches 4.5 V vs. Li/Li⁺ or more, an oxygen positional parameter of the positive active material determined from crystal structure analysis by a Rietveld method when a space group R3-m is used for a crystal structure model based on an X-ray diffraction pattern is 0.265 or more and 0.269 or less.

In the positive active material for a nonaqueous electrolyte energy storage device (A), the oxygen positional parameter in the charged state at a potential of 4.35 V vs. Li/Li⁺ in the state where there is no charge history in which the potential reaches 4.5 V vs. Li/Li⁺ or more is controlled within the above range, so that this oxygen positional parameter can he made substantially the same as the oxygen positional parameter in the charged state similar to the above of a positive active material which includes no aluminum and has the same composition in terms of a molar ratio of a transition metal element contained. In the positive active material for a nonaqueous electrolyte energy storage device, when the content of manganese in the transition metal is equal to or less than the upper limit, a charge-discharge cycle capacity retention ratio of the nonaqueous electrolyte energy storage device can be increased. Therefore, the positive active material for a nonaqueous electrolyte energy storage device can easily enhance the charge-discharge cycle capacity retention ratio and high rate discharge characteristics of the nonaqueous electrolyte energy storage device.

A positive active material for a nonaqueous electrolyte energy storage device (B) according to another aspect of the present invention is a positive active material for a nonaqueous electrolyte energy storage device containing a lithium transition metal composite oxide having an α-NaFeO₂ structure, the positive active material further containing aluminum, in which the lithium transition metal composite oxide contains at least one of nickel and cobalt, and manganese, and in a charged state at a potential of 4.35 V vs. Li/Li⁺ in a state where there is no charge history in which the potential reaches 4.5 V vs. Li/Li⁺ or more, an absolute value of a difference between an oxygen positional parameter of the positive active material determined from crystal structure analysis by a Rietveld method when a space group R3-m is used for a crystal structure model based on an X-ray diffraction pattern and an oxygen positional parameter of a positive active material, which contains no aluminum and has the same composition as the positive active material in terms of a molar ratio of a transition metal element contained, determined from the crystal structure analysis is 0.002 or less.

In the present specification, a composition ratio of the lithium transition metal composite oxide refers to a composition ratio when a completely discharged state is provided by the following method. First, the nonaqueous electrolyte energy storage device is subjected to constant current charge with a current of 0.05 C until the voltage becomes an end-of-charge voltage under normal usage, so that the energy storage device is brought to a fully charged state. After a 30-minute pause, the nonaqueous electrolyte energy storage device is subjected to constant current discharge with a current of 0.05 C to the lower limit voltage during normal usage. The energy storage device is disassembled, the positive electrode is taken out, and the positive electrode is cut into a sufficiently small area of about 1 to 10 cm². The positive electrode is used to assemble a battery having a metal lithium electrode as a counter electrode, and constant current discharge is performed at a current value of 10 mA per g of a positive composite until the voltage between terminals becomes 2.0 V, so that the positive electrode is adjusted to a fully discharged state in the composition analysis, the battery is disassembled again, and the positive electrode is taken out. Dimethyl carbonate is used to sufficiently wash a nonaqueous electrolyte attached on the taken out positive electrode, the positive electrode is dried at room temperature for an entire day and night, and then the positive composite peeled from the positive electrode substrate and collected is subjected to measurement. Operations from disassembly of the nonaqueous electrolyte energy storage device to collection of the positive composite are performed in an argon atmosphere having a dew point of −60° C. or lower. Here, the term “during normal usage” means use of the nonaqueous electrolyte energy storage device while employing charge-discharge conditions recommended or specified in the nonaqueous electrolyte energy storage device, and when a charger for the nonaqueous electrolyte energy storage device is prepared, this term means use of the nonaqueous electrolyte energy storage device by applying the charger.

In the present specification, the oxygen positional parameter is measured by the following procedure. First, the nonaqueous electrolyte energy storage device is subjected to constant current charge with a current of 0.05 C until the voltage becomes an end-of-charge voltage under normal usage, so that the energy storage device is brought to a fully charged state. After a 30-minute pause, the nonaqueous electrolyte energy storage device is subjected to constant current discharge with a current of 0.05 C to the lower limit voltage during normal usage. The energy storage device is disassembled, the positive electrode is taken out, and the positive electrode is cut into a sufficiently small area of about 1 to 10 cm². The positive electrode is used to assemble a battery having a metal lithium electrode as a counter electrode, and constant current discharge is performed at a current value of 10 mA per g of a positive composite until the voltage between terminals becomes 2.0 V, so that the positive electrode is adjusted to a fully discharged state. Subsequently, constant current constant voltage charge is performed at a charge current of 1.0 C and an end-of-charge voltage of 4.35 V. Here, since the counter electrode is metal lithium, the potential of a metal lithium counter electrode in an open circuit state is substantially equal to an oxidation/reduction potential of lithium, and thus when the end-of-charge voltage of the test battery is 4.35 V, the positive electrode achieved potential is considered to be 4.35 V vs. Li/Li⁺. In this charged state, the positive electrode is taken out in a dry room, and the composite peeled off from the positive electrode substrate without washing is crushed using a mortar and subjected to X-ray diffraction measurement. Crystal structure analysis by a Rietveld method is performed for diffraction lines except for peaks caused by metal aluminum used as the positive electrode substrate. RIETAN-2000 (Izumi et al., Mat. Sci. Forum, 321-324, 198 (2000)) is used as a program used for Rietveld analysis. As a profile function used for analysis, a pseudo-Voigt function of TCH is used. A peak position shift parameter is previously refined by using a silicon standard sample (Nast 640 c) having a known lattice constant. A crystal structure model of the positive active material is set to a space group R3-m, and the following parameters are refined at each atom position.
background parameter
lattice constant
oxygen position parameter
half width parameter of Gauss function
half width parameter of Lorentz function
asymmetry parameter
preferred-orientation parameter
isotropic atomic displacement parameter (however, fixed to 0.75 for Li atom)

Diffraction data between 15 and 85° (CuKα) is used as actual data, and this is refined to such an extent that a value of S indicating the degree of difference from the crystal model structure is reduced below 1.3. Background processing is performed by this refinement, and based on the result obtained by subtracting a background, a value of peak intensity of each diffraction line, a value of half width, and the like are obtained.

The present inventors have extensively conducted studies, and resultantly found that in the positive active material for a nonaqueous electrolyte energy storage device containing aluminum, by controlling the oxygen positional parameter in the charged state at a potential of 4.35 V vs. Li/Li⁺ in the state where there is no charge history in which the potential reaches 4.5 V vs, Li/Li⁺ or more, both the charge-discharge cycle capacity retention ratio and the high rate discharge characteristics of a nonaqueous electrolyte energy storage device including the positive active material for a nonaqueous electrolyte energy storage device (A) or (B) can be enhanced. In other words, the present inventors have found a new finding that the positive active material (A) or (B) for a nonaqueous electrolyte energy storage device can enhance both the charge-discharge cycle capacity retention ratio and the high rate discharge characteristics of the nonaqueous electrolyte energy storage device when the oxygen positional parameter in the charged state is substantially the same as the oxygen positional parameter in the charged state similar to the above of the positive active material which includes no aluminum and has the same composition in terms of the molar ratio of the transition metal element contained. In the positive active material (A) or (B) for a nonaqueous electrolyte energy storage device, for example, it is considered that the oxygen positional parameter can be controlled within a desired range by making a part of aluminum present on a surface of the lithium transition metal composite oxide while solid-solving another part of aluminum in the lithium transition metal composite oxide.

In the positive active material (B) for a nonaqueous electrolyte energy storage device, the content of manganese in the transition metal in the lithium transition metal composite oxide is preferably 0.3 or more and 0.7 or less in terms of molar ratio. As described above, by setting the content of manganese in the transition metal in the lithium transition metal composite oxide within the above range, the charge-discharge cycle capacity retention ratio of the nonaqueous electrolyte energy storage device including the positive active material for a nonaqueous electrolyte energy storage device (B) can he increased. In general, when such a lithium transition metal composite oxide containing a relatively high content of manganese is used, the increase in the internal resistance due to elution of manganese is likely to occur. On the other hand, since the positive active material for a nonaqueous electrolyte energy storage device (B) contains aluminum, even when manganese is contained in a ratio within the above range, an increase in internal resistance associated with a charge-discharge cycle is sufficiently suppressed.

A ratio of the number of moles of lithium to the number of moles of transition metal in the lithium transition metal composite oxide is preferably 1.0 or more and 1.4 or less. As described above, by setting the ratio of the number of moles of lithium to the number of moles of transition metal in the lithium transition metal composite oxide within the above range, it is possible to increase the discharge capacity of the nonaqueous electrolyte energy storage device while increasing the charge-discharge cycle capacity retention ratio of the nonaqueous electrolyte energy storage device.

In the positive active material for a nonaqueous electrolyte energy storage device (A) or (B), a ratio of the number of moles of aluminum to the number of moles of transition metal in the lithium transition metal composite oxide is preferably 0.1 or more and 2 or less. According to this configuration, it is easy to control the oxygen positional parameter to a desired range. Therefore, the charge-discharge cycle capacity retention ratio and the high rate discharge characteristics can be easily enhanced.

The positive active material for a nonaqueous electrolyte energy storage device (A) or (B) is a particle containing the lithium transition metal composite oxide, and a ratio of the number of moles of aluminum to a sum of the number of moles of transition metal and the number of moles of aluminum is preferably larger in the vicinity of the surface of the particle than that in the vicinity of the center of the particle. As described above, since the ratio of the number of moles of aluminum to the sum of the number of moles of transition metal and the number of moles of aluminum is larger in the vicinity of the surface than that in the vicinity of the center of the particle, the oxygen positional parameter can be more reliably controlled in a desired range. Therefore, the charge-discharge cycle capacity retention ratio and the high rate discharge characteristics can be more easily and reliably enhanced.

A positive electrode for a nonaqueous electrolyte energy storage device according to another aspect of the present invention includes either the positive active material (A) or the positive active material (B).

Since the positive electrode for a nonaqueous electrolyte energy storage device includes either the positive active material (A) or the positive active material (B), the charge-discharge cycle capacity retention ratio and the high rate discharge characteristics can be enhanced.

A nonaqueous electrolyte energy storage device according to another aspect of the present invention includes the positive electrode for a nonaqueous electrolyte energy storage device.

Since the nonaqueous electrolyte energy storage device includes the positive electrode for a nonaqueous electrolyte energy storage device, the charge-discharge cycle capacity retention ratio and the high rate discharge characteristics can be enhanced.

An energy storage apparatus according to another aspect of the present invention includes a plurality of nonaqueous electrolyte energy storage devices, and one or more of the nonaqueous electrolyte energy storage devices.

Since the energy storage apparatus includes one or more of the nonaqueous electrolyte energy storage devices, the charge-discharge cycle capacity retention ratio and the high rate discharge characteristics can be enhanced.

The positive electrode potential at the end-of-charge voltage under normal usage in the nonaqueous electrolyte energy storage device is preferably less than 4.5 V vs, Li/Li⁺. It is presumed that when the positive electrode potential at the end-of-charge voltage under normal usage of the nonaqueous electrolyte energy storage device is within the above range, the lithium transition metal composite oxide is gradually activated with charge-discharge repeated many times, and lithium ions desorbed from the lithium transition metal composite oxide during charge-discharge gradually increase (hereinafter, the fact that the “lithium transition metal composite oxide is gradually activated along with repeated charge-discharge under usage and the like” is also referred to as “temporal formation”). As a result, it is considered that consumption of lithium ions due to film formation in the negative electrode in the charge-discharge cycle can be replenished from the lithium transition metal composite oxide of the positive electrode, and the charge-discharge cycle capacity retention ratio can be easily increased.

A method for using a nonaqueous electrolyte energy storage device according to another aspect of the present invention includes charging at a positive electrode potential in a range of less than 4.5 V vs. Li/Li⁺.

According to the use method, the charge-discharge cycle capacity retention ratio and the high rate discharge characteristics can he enhance

A method for manufacturing a nonaqueous electrolyte energy storage device according to another aspect of the present invention includes performing initial charge-discharge at a positive electrode potential in a range of less than 4.5 V vs. Li/Li⁺.

According to the manufacturing method, it is possible to manufacture a nonaqueous electrolyte energy storage device excellent in the charge-discharge cycle capacity retention ratio and the high rate discharge characteristics.

In the present invention, “the ratio of the number of moles of aluminum to the sum of the number of moles of transition metal and the number of moles of aluminum is larger in the vicinity of the surface than that in the vicinity of the center of the particle” means that the ratio in a region including the surface of the positive active material for a nonaqueous electrolyte energy storage device is larger than the ratio in a region including the center of the particle containing the lithium transition metal composite oxide. As described in paragraphs 0088 to 0089 of Japanese Patent No. 5871186, the above ratio can be obtained by measuring a metal composition ratio from the surface of the particle to the center of the particle using a scanning electron microscope (SEM) and an energy dispersive X-ray analysis (EDX) apparatus. Here, when each region obtained by dividing a distance from the center of the particle to the surface of the particle into eight equal parts is defined as a measurement point, a central portion of the particle is defined as a Point 0, and an outermost surface portion of the particle is defined as a Point 8, the “vicinity of the center” and the “vicinity of the surface” mean a region of the Point 0 and a region of the Point 8, respectively.

Hereinafter, a positive active material for a nonaqueous electrolyte energy storage device, a positive electrode for a nonaqueous electrolyte energy storage device, a nonaqueous electrolyte energy storage device, an energy storage apparatus, a method for using a nonaqueous electrolyte energy storage device, and a method of manufacturing a nonaqueous electrolyte energy storage device according to one embodiment of the present invention will be described. In the present embodiment, a case where a nonaqueous electrolyte energy storage device is a nonaqueous electrolyte secondary battery (hereinafter, also simply referred to as a “secondary battery”) will be described.

### <Positive Active Material for Nonaqueous Electrolyte Energy Storage Device>

The positive active material for a nonaqueous electrolyte energy storage device (hereinafter, also simply referred to as “the positive active material”) contains a lithium transition metal composite oxide having an α-NaFeO₂ structure. The positive active material is a particle containing the lithium transition metal composite oxide. The positive active material further contains aluminum. The lithium transition metal composite oxide contains at least one of nickel and cobalt, and manganese. The positive active material preferably contains no metal element other than aluminum, lithium, and a transition metal. The fact that “the positive active material contains no metal element other than aluminum, lithium, and a transition metal” means that the content of metal elements other than aluminum, lithium, and a transition metal in the positive active material is 0.1% by mass or less, preferably 0.01% by mass or less.

In the positive active material, in the charged state at a potential of 4.35 V vs. Li/Li+ in the state where there is no charge history in which the potential reaches 4.5 V vs. Li/Li+ or more, an oxygen positional parameter (zO1) determined from crystal structure analysis by the Rietveld method. when the space group R3-m is used for the crystal structure model based on an X-ray diffraction pattern satisfies at least one of the following conditions (1) and (2).

(1) the oxygen positional parameter (zO1) is 0.265 or more and 0.269 or less

(2) an absolute value of a difference between the oxygen positional parameter (zO1) and an oxygen positional parameter (zO2) determined exactly similarly to as described above for a positive active material, which contains no aluminum and has the same composition as the positive active material in terms of a molar ratio of a transition metal element contained is 0.002 or less.

The oxygen positional parameter refers to a value of z when a space coordinate of a transition metal (Me) is defined as (0, 0, 0), the space coordinate of lithium is defined as (0, 0, 1/2), and the space coordinate of oxygen is defined as (0, 0, z) for an α-NaFeO₂-type crystal structure of the lithium transition metal composite oxide belonging to the space group R3-m. That is, the oxygen positional parameter is a relative index indicating how far the oxygen position is from the transition metal position.

When the positive active material. (A) satisfies the condition (1), the oxygen positional parameter (zO1) can be made substantially the same as the oxygen positional parameter (zO2). Accordingly, the positive active material can enhance the charge-discharge cycle capacity retention ratio and the high rate discharge characteristics of the energy storage device. The lower limit of the oxygen positional parameter (zO1) is preferably 0.266. The upper limit of the oxygen positional parameter (zO1) is preferably 0.968.

When the positive active material (B) satisfies the above condition (2), both the charge-discharge cycle capacity retention ratio and the high rate discharge characteristics of the nonaqueous electrolyte energy storage device (hereinafter, also simply referred to as “the energy storage device”) including the positive active material can be enhanced. When the condition (2) is satisfied, the oxygen positional parameter (zO2) is preferably an oxygen positional parameter of the positive active material in which the ratio of the number of moles of lithium to the number of moles of transition metal is the same as that of the positive active material. The upper limit of the absolute value of the difference between the oxygen positional parameter (zO1) and the oxygen positional parameter (zO2) is preferably 0.001. In the positive active material, for example, it is considered that the oxygen positional parameter (zO1) can be controlled to be substantially the same as the oxygen positional parameter (zO2) by making a part of aluminum present on the surface of the lithium transition metal composite oxide while solid-solving another part of aluminum in the lithium transition metal composite oxide.

When the content (mol) of the transition metal is denoted by X_{Me} and the content (mol) of manganese (Mn) is denoted by X_{Mn}, the upper limit of the content (X_{Mn}/X_{Me}) of Mn in the transition metal (Me) in the lithium transition metal composite oxide is preferably 0.7, more preferably 0.6, still more preferably 0.55. In particular, when the positive active material satisfies the condition (2), the upper limit of the content (X_{Mn}/X_{Me}) is preferably 0.6. By setting the content (X_{Mn}/X_{Me}) to be equal to or less than the above upper limit, the charge-discharge cycle capacity retention ratio of the energy storage device can be increased.

The positive active material (B) is suitable for improving the charge-discharge cycle capacity retention ratio and the high rate discharge characteristics of the energy storage device when a lithium transition metal composite oxide containing a relatively high content of manganese is used. The lower limit of the content (X_{Mn}/X_{Me}) of Mn in the transition metal (Me) in the lithium transition metal composite oxide is preferably 0.1, more preferably 0.3, still more preferably 0.4. By setting the content (X_{Mn}/X_{Me}) to be equal to or more than the above lower limit, an action of temporal formation is enhanced, and the charge-discharge cycle capacity retention ratio can be increased.

When the content (mol) of nickel (Ni) is denoted by X_{Ni}, the lower limit of the content (X_{Ni}/X_{Me}) of Ni in the transition metal (Me) in the lithium transition metal composite oxide may be, for example, 0, and is preferably 0.1, more preferably 0.2, still more preferably 0.3. On the other hand, the upper limit of the content (X_{Ni}/X_{Me}) may be, for example, 0.7, and is preferably 0.6, and more preferably 0.5. By setting the content (X_{Ni}/X_{Me}) to be equal to or more than the above lower limit, output performance, energy density, and the like can be enhanced. By setting the content (X_{Ni}/X_{Me}) to be equal to or less than the above upper limit, the charge-discharge cycle capacity retention ratio can he increased.

When the content (mol) of cobalt (Co) is X_{Co}, the lower limit of the content (X_{Co}/X_{Me}) of Co in the transition metal (Me) in the lithium transition metal composite oxide may be, for example, 0, and is preferably 0.1. On the other hand, the upper limit of the content (X_{Co}/X_{Me}) may be, for example, 0,6, and is preferably 0.3. By setting the content (X_{Co}/X_{Me}) to be equal to or more than the above lower limit, the output performance, the energy density, and the like can be enhanced. Conversely, by setting the content (X_{Co}/X_{Me}) to be equal to or less than the above upper limit, it is possible to suppress the raw material cost while exhibiting a sufficient charge-discharge cycle capacity retention ratio.

When the content (mol) of lithium (Li) is X_{Li}, the lower limit of a ratio (X_{Li}/X_{Me}) of the number of moles of lithium (Li) to the number of moles of transition metal (Me) in the lithium transition metal composite oxide may be, for example, 1.0, and is preferably more than 1.0, more preferably 1.05, and still mole preferably 1.1. On the other hand, the upper limit of the ratio (X_{Li}/X_{Me}) is preferably 1.5, more preferably 1.4, and still more preferably 1.3. In particular, when the condition (2) is satisfied, the upper limit of the ratio (X_{Li}/X_{Me}) is preferably 1.3. When the ratio (X_{Li}/X_{Me}) is within the above range, the charge-discharge cycle capacity retention ratio of the energy storage device can be increased, and the discharge capacity can he increased. When the ratio (X_{Li}/X_{Me}) is more than 1.0, the positive active material is configured as a so-called lithium-excess-type active material.

The aluminum increases the charge-discharge cycle capacity retention ratio of the energy storage device. A presence mode of aluminum is not particularly limited, and aluminum may be solid-solved in the lithium transition metal composite oxide, or may be present as a component different from the lithium transition metal composite oxide. However, in the positive active material, it is preferable that a part of aluminum is solid-solved in the lithium transition metal composite oxide, and another part is present on the surface of the lithium transition metal composite oxide as a component different from the lithium transition metal composite oxide.

When a part of aluminum is solid-solved in the lithium transition metal composite oxide, the lithium transition metal composite oxide may be represented by, for example, Li_{1+α}(Ni_{β}Co_{γ}Mn_{δ}Alᵣ)_{1-α}O₂ (0<α<1, 0≤β<1, 0≤y<1, 0<δ<, 0<<ϵ<1, β+γ+δ+ϵ=1, β+γ≠0).

When the content (mol) of aluminum (Al) in the positive active material is X_{Al}, the lower limit of a ratio (X_{Al}/X_{Me}) of the number of moles of aluminum (Al) to the number of moles of the transition metal (Me) in the entire positive active material is preferably 0.02, and more preferably 0.05. Meanwhile, the upper limit of the ratio (X_{Al}/X_{Me}) is preferably 2.5, more preferably 1.7. By setting the ratio (X_{Al}/X_{Me}) within the above range, the oxygen positional parameter (zO1) can be easily controlled within the above desired range. Therefore, the charge-discharge cycle capacity retention ratio and the high rate discharge characteristics of the energy storage device can be easily and reliably enhanced.

In the positive active material, a ratio of the number of moles of aluminum (Al) to the sum of the number of moles of the transition metal (Me) and the number of moles of aluminum (Al) is preferably larger in the vicinity of the surface than that in the vicinity of the center of the particle containing the lithium transition metal composite oxide. In the positive active material, as described above, a part of aluminum (Al) is solid-solved in the lithium transition metal composite oxide, and another part of aluminum (Al) is present on the surface of the particle containing the lithium transition metal composite oxide, so that the ratio in the vicinity of the surface of the particle can be made larger than the ratio in the vicinity of the center of the particle. In the positive active material, the charge-discharge cycle capacity retention ratio of the energy storage device can be increased by increasing the ratio in the vicinity of the surface of the particle containing the lithium transition metal composite oxide. On the other hand, in the positive active material, when the ratio in the vicinity of the surface of the particle is too large, the high rate discharge characteristics are deteriorated. From this viewpoint, the aluminum is made present while being dispersed in and out of the particles containing the lithium transition metal composite oxide, so that the energy storage device can sufficiently increase the charge-discharge cycle capacity retention ratio while maintaining the high rate discharge characteristics.

Here, the content of aluminum in the positive active material is a value measured by ICP (inductively coupled plasma) emission spectrometry.

The lithium transition metal composite oxide may contain other metal elements and the like as long as the effect of the present invention is exhibited, and other metal elements and the like may be mixed as impurities. When the lithium transition metal composite oxide contains other metal elements, the oxygen positional parameter (zO2) is preferably an oxygen positional parameter of the positive active material in which the ratio of the number of moles of other metal elements to the number of moles of transition metal is the same as that of the positive active material.

The positive active material may contain a positive active material other than the lithium transition metal composite oxide. The other positive active material can be appropriately selected from known positive active materials usually used for lithium ion secondary batteries and the like. As the other positive active material, a material capable of occluding and releasing lithium ions is usually used. Examples thereof include the LiMeO₂-type active material described above, lithium transition metal oxides having a spinel-type crystal structure, polyanion compounds, chalcogenides, and sulfur. However, the content of the lithium transition metal composite oxide in the whole positive active material contained in the positive active material is preferably 80% by mass or more, more preferably 90% by mass or more, still more preferably 99% by mass or more, and even more preferably 100% by mass.

The average particle size of the positive active material is preferably 0.1 μm or more and 20 μm or less, for example. By setting the average particle size of the positive active material to be equal to or more than the above lower limit, the positive active material is easily manufactured or handled. By setting the average particle size of the positive active material to be equal to or less than the upper limit, the electron conductivity of the positive active material layer is improved. Here, the term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

### (Method of Producing Positive Active Material)

As a method of producing the positive active material (positive active material particles), examples include (1) a method in which a particulate positive active material is immersed in a liquid obtained by dissolving or suspending an aluminum compound (compound containing aluminum) and then dried, (2) a method in which a particulate positive active material is immersed in a liquid obtained by dissolving or suspending an aluminum compound and then reacted by heating or the like, (3) a method in which a mixture containing a positive active material precursor, a lithium compound, and an aluminum compound is fired, (4) a method in which a mixture containing an aluminum compound and a particulate positive active material is fired, and (5) a method in which a mixture containing a positive active material precursor containing aluminum and a lithium compound is fired. Among these methods, (5) the method in which a mixture containing a positive active material precursor containing aluminum and a lithium compound is fired is preferable. By producing the positive active material by such a method, it is easy to allow a part of aluminum to be present on the surface of the lithium transition metal composite oxide while solid-solving another part of aluminum in the lithium transition metal composite oxide. In particular, in the positive active material, an aqueous solution containing nickel, cobalt, manganese, and the like and an aqueous solution containing aluminum are separately added dropwise to water in a reaction tank and mixed to prepare a positive active material precursor, and then a mixture containing the positive active material precursor and a lithium compound is fired to adjust a solid solution amount of aluminum in the lithium transition metal composite oxide, and it is easy to suitably control the oxygen positional parameter (zO1). Hereinafter, a method of producing a positive active material according to the method (5) will be described in detail.

The positive active material precursor is preferably a coprecipitation precursor in which nickel, cobalt, manganese, aluminum, and the like are present in one particle.

The precursor is prepared using a reactive crystallization method. Here, examples of the coprecipitation precursor generally include a hydroxide precursor and a carbonate precursor. Here, in a method of producing a carbonate precursor, a crystallization rate is high, and it is difficult to control the solid solution amount of aluminum, whereas in a method of producing a hydroxide precursor, it is easy to control the crystallization rate by applying a complexing agent, so that it is easy to adjust the solid solution amount of aluminum. From this viewpoint, in particular, the method of producing a hydroxide precursor is preferable from the viewpoint of adjusting the solid solution amount of aluminum in the lithium transition metal composite oxide.

In the case of producing the hydroxide precursor, it is preferable to add an alkali aqueous solution containing an alkali metal hydroxide (neutralizing agent), a complexing agent, and a reducing agent together with an aqueous solution containing a transition metal (Me) and aluminum to water (aqueous solution) in a reaction tank maintaining alkalinity to coprecipitate a transition metal hydroxide as an aluminum hydroxide. As the complexing agent, ammonia (NH₃), ammonium sulfate, ammonium nitrate or the like can be used. As the reducing agent, hydrazine, sodium borohydride, or the like can be used. As the alkali metal hydroxide, sodium hydroxide, lithium hydroxide, potassium hydroxide, or the like can be used.

In the case of producing the carbonate precursor, it is preferable to add an alkali aqueous solution containing a neutralizing agent such as sodium carbonate or lithium carbonate and a complexing agent together with am aqueous solution containing a transition metal (Me) and aluminum to water (aqueous solution) in a reaction tank maintaining alkalinity to coprecipitate a transition metal carbonate and an aluminum carbonate.

Regarding the raw material of the precursor, examples of the Ni compound include nickel hydroxide, nickel carbonate, nickel sulfate, nickel nitrate, and nickel, acetate. Examples of the Co compound include cobalt sulfate, cobalt nitrate, and cobalt acetate. Examples of the Mn compound include manganese oxide, manganese carbonate, manganese sulfate, manganese nitrate, and manganese acetate.

In preparation of a precursor, since Mn is easily oxidized, for example, it is not easy to prepare a precursor in which Ni, Co and Mn are uniformly distributed in a divalent state, and thus uniform mixing of Ni, Co and Mn at an atomic level is likely to be insufficient. Therefore, in order to suppress the oxidation of Mn present in the precursor, it is preferable to remove water or dissolved oxygen in the aqueous solution. Examples of the method for removing dissolved oxygen include a method in which the solution is bubbled using a gas free of oxygen. The gas free of oxygen is not particularly limited, and examples of the gas include nitrogen gas, argon gas, and carbon dioxide gas.

Regarding dropwise addition of a raw material aqueous solution, it is preferable to separately add dropwise the aqueous solution containing the transition metal (Me) and the aqueous solution containing Al. According to this method, it is difficult for Al to be uniformly dispersed in the transition metal (Me). More specifically, it is difficult for the transition metal hydroxide and the aluminum hydroxide to be uniformly mixed. As a result, it is easy to adjust the solid solution amount of aluminum in the lithium transition metal composite oxide. When a precursor is prepared in an aqueous solution, pH of the aqueous solution, a dropwise addition rate of a raw material aqueous solution, and the like are not particularly limited, and conditions similar to conventionally known production conditions can be employed. The pH of the aqueous solution can be, for example, 8 to 11, and may be 9.5 to 10.5. The dropwise addition rate of the raw material aqueous solution may be, for example, 0.1 cm³/min or more and 10 cm³/min or less.

When a complexing agent such as NH₃ is present in the reaction tank, and certain convection conditions are applied, rotation and revolution, in a stirring tank, of particles are promoted by further continuing stirring after completion of dropwise addition of the raw material aqueous solution, and in this process, the particles are grown stepwise into a concentric circular sphere while colliding with one another. That is, a coprecipitation precursor is formed through reactions in two stages, i.e. a metal complex formation reaction when the raw material aqueous solution is added dropwise into the reaction tank and a precipitate formation reaction that occurs during retention of the metal complex in the reaction tank.

The preferred stirring duration after the end of dropwise addition of the raw material aqueous solution, that, is, the reaction time depends on the size of a reaction tank, stirring conditions, the pH, the reaction temperature and the like, and the stirring duration is, for example, preferably 0.5 hours or more and 20 hours or less, and more preferably 1 hour or more and 15 hours or less.

The precursor (positive active material precursor) obtained by the above method and a Li compound are mixed and fired to obtain positive active material particles. As the Li compound, lithium hydroxide, lithium carbonate, or the like can be used, in addition to these Li compounds, LiF, Li₂SO₄, or Li₃PO₄ can be used as a sintering aid. The ratio of such a sintering aid added is preferably 1 to 10 mol % based on the total amount of the Li compounds. The total amount of the Li compounds is preferably excessive by about 1 to 5 mol % in anticipation of loss of a part of the Li compounds during firing.

The firing temperature is preferably 750° C. or higher and 1,000° C. or lower. By setting the firing temperature to be equal to or greater than the above lower limit, positive active material particles having a high degree of sintering can be obtained, and charge-discharge cycle performance can be improved. On the other hand, by setting the firing temperature to be equal to or less than the above upper limit, it is possible to suppress a decrease in discharge performance due to, for example, a structural change from a layered α-NaFeO₂ structure to a rock salt type cubic crystal structure.

A crusher, a classifier, and the like are used to obtain particles such as positive active material particles in a predetermined shape. Examples of a crushing method include a method in which a mortar, a ball mill, a sand mill, a vibratory ball mill, a planetary ball mill, a jet mill, a counter jet a whirling airflow type jet mill, or a sieve or the like is used. At the time of crushing, wet type crushing in the presence of water or an organic solvent such as hexane can also be used. As a classification method, a sieve or a wind force classifier or the like is used based on the necessity both in dry manner and in wet manner.

### <Positive Electrode for Nonaqueous Electrolyte Energy Storage Device>

The positive electrode for the energy storage device (hereinafter, also simply referred to as “the positive electrode”) has a positive substrate and a positive active material layer disposed directly or via an intermediate layer on the positive substrate. The positive active material layer contains the positive active material. Since the positive electrode includes the positive active material, the charge-discharge cycle capacity retention ratio and the high rate discharge characteristics can be enhanced.

The positive electrode substrate has conductivity. Having “conductivity” means having a volume resistivity of 10⁷ Ω cm or less that is measured in accordance with JIS-11-0505 (1975), and the term “non-conductivity” means that the volume resistivity is more than 10⁷ Ω cm. As the material of the positive electrode substrate, a metal such as aluminum, titanium, tantalum, or stainless steel, or an alloy thereof is used. Among these, aluminum or an aluminum alloy is preferable from the viewpoint of electric potential resistance, high conductivity, and costs. Examples of the positive electrode substrate include a foil and a deposited film, and a foil is preferable from the viewpoint of costs. Therefore, the positive electrode substrate is preferably an aluminum foil or an aluminum alloy foil. Examples of the aluminum or aluminum alloy include A1085 and A3003 specified in JIS-H-4000 (2014).

An average thickness of the positive electrode substrate is preferably 5 μm or more and 50 μm or less, and more preferably 10 μm or more and 40 μm or less. By setting the average thickness of the positive electrode substrate to be equal to or greater than the lower limit, the strength of the positive electrode substrate can be increased. By setting the average thickness of the positive electrode substrate to be equal to or less than the above upper limit, the energy density per volume of the secondary battery can be increased. The “average thickness” of the substrate refers to a value obtained by dividing a cutout mass in cutout of a substrate having a predetermined area by a true density and a cutout area of the substrate. The “average thickness” of the negative electrode substrate described later is similarly defined.

The intermediate layer is a layer arranged between the positive electrode substrate and the positive active material layer. The configuration of the intermediate layer is not particularly limited, and includes, for example, a resin binder and conductive particles. The intermediate layer contains, for example, conductive particles such as carbon particles to reduce contact resistance between the positive electrode substrate and the positive active material layer.

The positive active material layer is a layer of a positive composite containing the positive active material. The positive active material layer (positive composite) may contain, in addition to the positive active material, optional components, such as a conductive agent, a binder, a thickener, and a filler, as necessary.

The content of the positive active material in the positive active material layer (positive composite) is preferably 70% by mass or more and 98% by mass or less, more preferably 80% by mass or more and 97% by mass or less, still more preferably 90% by mass or more and 96% by mass or less. The content of the positive active material within the range mentioned above allows an increase in the electric capacity of the secondary battery.

The conductive agent is not particularly limited as long as it is a material exhibiting conductivity. Examples of such a conductive agent include graphite; carbon blacks such as furnace black and acetylene black; metals; and conductive ceramics. Examples of the shape of the conductive agent include a powdery shape and a fibrous shape. Among these, acetylene black is preferable from the viewpoint of electron conductivity and coatability.

The content of the conductive agent in the positive active material layer (positive composite) is preferably 1% by mass or more and 10% by mass or less, and more preferably 2% by mass or more and 5% by mass or less. By setting the content of the conductive agent within the above range, the electric capacity of the secondary battery can be increased.

Examples of the binder include: thermoplastic resins such as fluororesin (polytetrafluoroethylene (PTFE), polyvinylidene fluoride (PVDF), etc.), polyethylene, polypropylene, and polyimide: elastomers such as ethylene-propylene-diene rubber (EPDM), sulfonated EPDM, styrene-butadiene rubber (SBR), and fluororubber; and polysaccharide polymers.

The content of the binder in the positive active material layer (positive composite) is preferably 1% by mass or more and 10% by mass or less, and more preferably 2% by mass or more and 5% by mass or less. When the content of the binder is within the above-described range, the active material can be stably held.

Examples of the thickener include polysaccharide polymers such as carboxymethylcellulose (CMC) and methylcellulose. When the thickener has a functional group that is reactive with lithium and the like, the functional group may be deactivated by methylation or the like in advance.

The filler is not particularly limited. Examples of the filler include polyolefins such as polypropylene and polyethylene, silica, alumina, zeolite, glass, and alumina silicate.

The positive active material layer may contain a typical n element such as B, N, P, F, Cl, Br, or I, a typical metal element such as Li, Na, Mg, Imo, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material particles, the conductive agent, the binder, the thickener, and the filler.

### <Nonaqueous Electrolyte Energy Storage Device>

The energy storage device includes the above-described positive electrode, a negative electrode, and a nonaqueous electrolyte. The positive electrode and the negative electrode usually form an electrode assembly alternately superposed by stacking or winding with a separator interposed therebetween. The electrode assembly is housed in a case, and the case is filled with the nonaqueous electrolyte. The nonaqueous electrolyte is interposed between the positive electrode and the negative electrode. As the case, a known metal case or resin case or the like, which is usually used, can be used. Since the energy storage device includes the positive electrode, the charge-discharge cycle capacity retention ratio and the high rate discharge characteristics can be enhanced.

### (Negative Electrode)

The negative electrode has a negative electrode substrate and a negative active material layer disposed directly or via an intermediate layer on the negative electrode substrate. The configuration of the intermediate layer of the negative electrode is not particularly limited, and the intermediate layer can have the same configuration as that of the intermediate layer of the positive electrode.

The negative electrode substrate exhibits conductivity. As the material of the negative electrode substrate, a metal such as copper, nickel, stainless steel, nickel-plated steel, or aluminum, or an alloy thereof is used. Among them, copper or a copper alloy is preferable. Examples of the negative electrode substrate include a foil and a vapor deposited film, and a foil is preferable from the viewpoint of cost. Therefore, the negative electrode substrate is preferably a copper foil or a copper alloy foil. Examples of the copper foil include a rolled copper foil and an electrolytic copper foil.

An average thickness of the negative electrode substrate is preferably 3 μm or more and 30 μm or less, and more preferably 5 μm or more and 20 μm or less. By setting the average thickness of the negative electrode substrate to be equal to or greater than the above lower limit, the strength of the negative electrode substrate can be increased. By setting the average thickness of the negative electrode substrate to be equal to or less than the above upper limit, the energy density per volume of the secondary battery can be increased.

The negative active material layer is a layer of a negative composite containing a negative active material. The negative active material layer (negative composite) may contain, in addition to the negative active material, optional components, such as a conductive agent, a binder, a thickener, and a filler, as necessary. As the optional components such as a conductive agent, a hinder, a thickener, and a filler, the same components as those in the positive active material layer can be used. The contents of these optional components in the negative active material layer can be within the ranges described as the contents of the components in the positive active material layer.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). In the negative active material layer, one of these materials may be used singly, or two or more of these materials may be used in mixture.

The term “graphite” refers to a carbon material in which an average grid distance (d₀₀₂) of a (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average lattice distance (d₀₀₂) of the (002) plane determined by the X-ray diffraction method. before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

Here, the “discharged state” defining graphite and non-graphite carbon refers to a state where an open circuit voltage is 0.7 V or more in a unipolar battery using a negative electrode, containing a carbon material as a negative active material, as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/reduction potential of Li. That is, the fact that the open circuit voltage in the unipolar battery is 0.7 V or more means that lithium ions that can be occluded and released in association with charge-discharge are sufficiently released from the carbon material that is the negative active material.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

In order to obtain a secondary battery having a high capacity retention ratio, the negative active material is preferably a carbon material, and more preferably graphite. When a carbon material is used as the negative active material, the content of the carbon material in all the negative active materials may be 50% by mass or more, 70% by mass or more, 90% by mass or more, or substantially 100% by mass.

The negative active material is typically particles (powder). The average particle size of the negative active material can be, for example, 1 nm or more and 100 μm or less. By setting the average particle size of the negative active material to be equal to or greater than the above lower limit, the negative active material is easily produced or handled. By setting the average particle size of the negative active material to be equal to or less than the above upper limit, the electron conductivity of the positive active material layer is improved. A crusher, a classifier, and the like are used to obtain a powder having a predetermined particle size. A crushing method and a powder classification method can be selected from, for example, the methods exemplified for the positive electrode.

The content of the negative active material in the negative active material layer (negative composite, is preferably 60% by mass or more and 99% by mass or less, and more preferably 90% by mass or more and 98% by mass or less. When the content of the negative active material falls within the above range, it is possible to achieve both high energy density and productivity of the negative active material layer.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

### (Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles included in the heat resistant layer preferably have a mass loss of 5% or less in the case of heating from room temperature to 500° C. under the atmosphere, and more preferably have a mass loss of 5% or less in the case of heating from room temperature to 800° C. under the atmosphere. Inorganic compounds can be mentioned as materials whose mass loss is less than or equal to a predetermined value when the materials are heated. Examples of the inorganic compound include: oxides such as iron oxide, silicon oxide, aluminum oxide, titanium dioxide, zirconium oxide, calcium oxide, strontium oxide, barium oxide, magnesium oxide, and aluminosilicate; hydroxides such as magnesium hydroxide, calcium hydroxide, and aluminum hydroxide; nitrides such as aluminum nitride and silicon nitride; carbonates such as calcium carbonate; sulfates such as barium sulfate; hardly soluble ionic crystals such as calcium fluoride, barium fluoride, and barium titanate; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compounds, a simple substance or a complex of these substances may be used alone, or two or more thereof may be used in mixture. Among these inorganic compounds, silicon oxide, aluminum oxide, or aluminosilicate is preferable from the viewpoint of safety of the secondary battery.

The porosity of the separator is preferably 80% by volume or less from the viewpoint of strength, and is preferably 20% by volume or more from the viewpoint of discharge performance. The “porosity” herein is a volume-based value, and means a value measured with a mercury porosimeter.

As the separator, a polymer gel composed of a polymer and a nonaqueous electrolyte may he used. Examples of the polymer include polyacrylonitrile, polyethylene oxide, polypropylene oxide, polymethyl methacrylate, polyvinyl acetate, polyvinylpyrrolidone, and polyvinylidene fluoride. The use of the polymer gel has the effect of suppressing liquid leakage. As the separator, a polymer gel may be used in combination with a porous resin film, a nonwoven fabric, or the like as described above.

### (Nonaqueous Electrolyte)

The nonaqueous electrolyte can be appropriately selected from known nonaqueous electrolytes. As the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used. For example, by using a fluorinated compound (fluorinated cyclic carbonate, fluorinated chain carbonate, etc.), it can be sufficiently used even under use conditions where the positive electrode potential reaches a high potential.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these, EC, PC, and FEC are preferable.

Examples of the chain carbonate include diethyl carbonate (DEC), dimethyl carbonate (DMC), ethyl methyl carbonate (EMC), diphenyl carbonate, methyl trifluoroethyl carbonate (MFEC), and bis(trifluoroethyl)carbonate. Among these, EMC and MFEC are preferable.

As the nonaqueous solvent, it is preferable to use the cyclic carbonate or the chain carbonate, and it is more preferable to use the cyclic carbonate and the chain carbonate in combination. By using the cyclic carbonate, dissociation of the electrolyte salt can be promoted to improve ionic conductivity of the nonaqueous electrolyte solution. By using the chain carbonate, the viscosity of the nonaqueous electrolyte solution can be kept low. When the cyclic carbonate and the chain carbonate are used in combination, the volume ratio of the cyclic carbonate to the chain carbonate (cyclic carbonate chain carbonate) preferably falls within the range from 5:95 to 50:50, for example.

The electrolyte salt can be appropriately selected from known electrolyte salts. Examples of the electrolyte salt, include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃, Among these salts, an inorganic lithium salt is preferable, and LiPF₆ is more preferable.

The content of the electrolyte salt in the nonaqueous electrolyte solution is preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, and particularly preferably 0.7 mol/dm³ or more and 1.5 mol/dm³ or less. The content of the electrolyte salt falls within the above range, thereby allowing the ionic conductivity of the nonaqueous electrolyte solution to be increased.

The nonaqueous electrolyte solution may contain an additive. Examples of the additive include aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. These additives may be used singly, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to a total mass of the nonaqueous electrolyte solution. When the content of the additive falls within the above range, it is possible to improve capacity retention performance or charge-discharge cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from any material having ionic conductivity such as lithium, sodium and calcium and being solid at room temperature (for example, 15° C. or higher and 25° C. or lower). Examples of the solid electrolyte include sulfide solid electrolytes, oxide solid electrolytes, oxynitride solid electrolytes, and polymer solid electrolytes.

Examples of the sulfide solid electrolyte include Li₂S—P₂S₅, LiI—Li₂S—P₂S₅, and Li₁₀Ge—P₂S₁₂.

### (Positive Electrode Potential at End-of-Charge Voltage Under Normal Usage)

In the energy storage device, the positive electrode potential (positive electrode achieved potential) at the end-of-charge voltage under normal usage is not particularly limited, and is preferably less than 4.5 V vs. Li/Li⁺ more preferably less than 4.45 V vs. Li/Li⁺, and still more preferably less than 4.4 V vs. Li/Li⁺ in some cases, By setting the positive electrode potential at the end-of-charge voltage under normal usage to be equal to or less than the above upper limit, the temporal formation gradually proceeds with charge-discharge repeated many times, so that the charge-discharge cycle capacity retention ratio can be increased. According to this configuration, it is considered that the change in the crystal structure in a direction in which a diffusion rate of lithium ions in the solid phase decreases is easily suppressed. Thus, it is possible to suppress the increase in internal resistance associated with the charge-discharge cycle.

In the energy storage device, the positive electrode potential at the end-of-charge voltage under normal usage is preferably more than 4.25 V vs. Li/Li⁺, more preferably 4.3 V vs. Li/Li⁺ or more, and still more preferably 4.35 V vs. Li/Li⁺ or more in some cases. By setting the positive electrode potential at the end-of-charge voltage under normal usage to be equal to or more than the above lower limit, the temporal formation sufficiently proceeds during normal charge, so that the charge-discharge cycle capacity retention ratio can be increased. By setting the positive electrode potential at the end-of-charge voltage under normal usage to be equal to or more than the above lower limit, the discharge capacity can be increased, and the energy density, the output performance, and the like can be enhanced.

The positive electrode potential at the end-of-charge voltage under normal usage in the energy storage device may be within a range between any of the above upper limits and any of the above lower limits.

### <Method for Using Nonaqueous Electrolyte Energy Storage Device>

The method for using the nonaqueous electrolyte energy storage device (secondary battery) according to one embodiment of the present invention is not particularly limited, and the following method is preferable. That is, the method for using an energy storage device includes charging at a positive electrode potential (positive electrode achieved potential) in a range of less than 4.5 V vs. Li/Li⁺. According to the use method, the charge-discharge cycle capacity retention ratio and. the high rate discharge characteristics can be enhanced. Furthermore, according to the use method, it is possible to suppress the increase in internal resistance associated with the charge-discharge cycle.

The upper limit of the positive electrode potential (positive electrode achieved potential) in this charge is more preferably less than 4.45 V vs. Li/Li⁺, and still more preferably less than 4.4 V vs. Li/Li⁺ in some cases. The lower limit of the positive electrode potential in this charge is preferably more than 4.25 V vs. Li/Li⁺, more preferably 4.3 V vs. Li/Li⁺, and still more preferably 4.35 V vs. Li/Li⁺ in some cases.

This use method may be the same as a conventionally known method for using a secondary battery except that the positive electrode potential (positive electrode achieved potential) in the charge is set as described above.

### <Method for Manufacturing Nonaqueous Electrolyte Energy Storage Device>

A method for manufacturing a nonaqueous electrolyte energy storage device (secondary battery) according to one embodiment of the present invention includes assembling an uncharged and undischarged. nonaqueous electrolyte energy storage device including a positive electrode, a negative electrode, and a nonaqueous electrolyte, and initially charging and discharging the uncharged and undischarged nonaqueous electrolyte energy storage device. In this initial charge-discharge, the initial charge-discharge is performed in a range in which the positive electrode potential. (positive electrode achieved potential) is less than 4.5 V vs. Li/Li⁺. The positive electrode includes the positive active material described above. According to the manufacturing method, it is possible to manufacture a nonaqueous electrolyte energy storage device excellent in the charge-discharge cycle capacity retention ratio and the high rate discharge characteristics. According to the manufacturing method, it is possible to manufacture a nonaqueous electrolyte energy storage device in which the increase in internal resistance associated with the charge-discharge cycle is suppressed.

In the manufacturing method, the initial charge-discharge does not actively activate the positive active material, and may be performed, for example, for confirming the capacity. That, is, the initial charge-discharge is simply charge-discharge performed for the first time after assembling the uncharged and undischarged nonaqueous electrolyte energy storage device. The number of times of charge and discharge in the initial charge-discharge may be 1 or 2, or may he 3 or more.

The upper limit of the positive electrode potential (positive electrode achieved potential) in the initial charge-discharge is less than 4.45 V vs. Li/Li⁺, and less than 4.4 V vs. Li/Li⁺ in some cases. On the other hand, the lower limit of the positive electrode potential in the initial charge-discharge is not particularly limited, and may be, for example, more than 4.25 V vs. Li/Li⁺, and may be 4.3 V vs. Li/Li⁺, or 4.35 V vs. Li/Li⁺.

Assembling the uncharged and undischarged nonaqueous electrolyte energy storage device including the positive electrode, the negative electrode, and the nonaqueous electrolyte includes, for example, preparing an electrode assembly, preparing a nonaqueous electrolyte, and housing the electrode assembly and the nonaqueous electrolyte in a case. The preparation of the electrode assembly includes: preparing a positive electrode, preparing a negative electrode, and forming an electrode assembly by stacking or winding the positive electrode and the negative electrode with a separator interposed therebetween.

The positive electrode can be prepared by applying a positive composite paste to a positive electrode substrate directly or via an intermediate layer, followed by drying. The positive composite paste contains components constituting a positive active material layer (positive composite) such as a positive active material, and a dispersion medium. A preferred method of producing the positive active material is as described above.

The negative electrode can be prepared, for example, by applying a negative composite paste to a negative electrode substrate directly or via an intermediate layer, followed by drying. The negative composite paste contains components constituting a negative active material layer (negative composite) such as a negative active material, and a dispersion medium.

### <Specific Configuration of Nonaqueous Electrolyte Energy Storage Device>

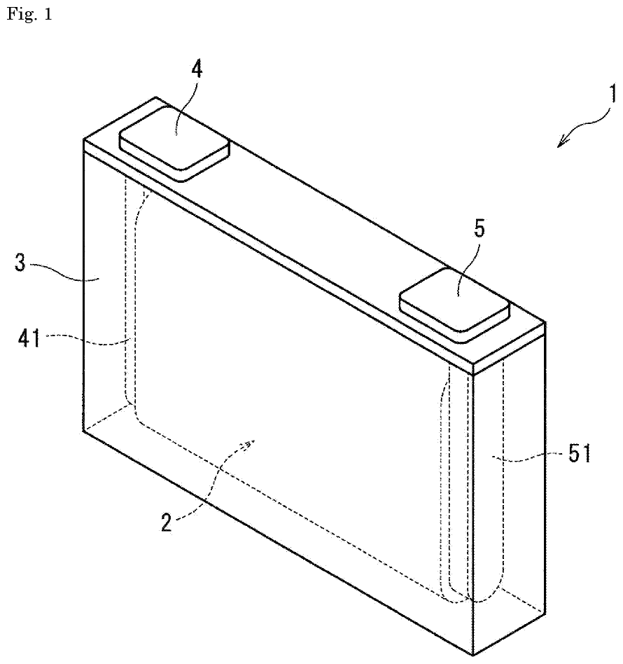

The configuration of the nonaqueous electrolyte energy storage device according to the present invention is not particularly limited, and examples thereof include cylindrical batteries, prismatic batteries (rectangular batteries), and flat batteries. FIG. 1 is a schematic view of a rectangular nonaqueous electrolyte energy storage device 1 (nonaqueous electrolyte secondary battery), which is an embodiment of the nonaqueous electrolyte energy storage device according to the present invention. FIG. 1 is a view showing an inside of a case in a perspective manner. In the nonaqueous electrolyte energy storage device 1 shown in FIG. 1, an electrode assembly 2 is housed iii a case 3. The electrode assembly 2 is formed by winding a positive electrode provided with the positive active material and a negative electrode provided with a negative active material via a separator. The positive electrode is electrically connected to a positive electrode terminal 4 through a positive electrode lead 41, and the negative electrode is electrically connected to a negative electrode terminal 5 through a negative electrode lead 51.

### <Energy Storage Apparatus>

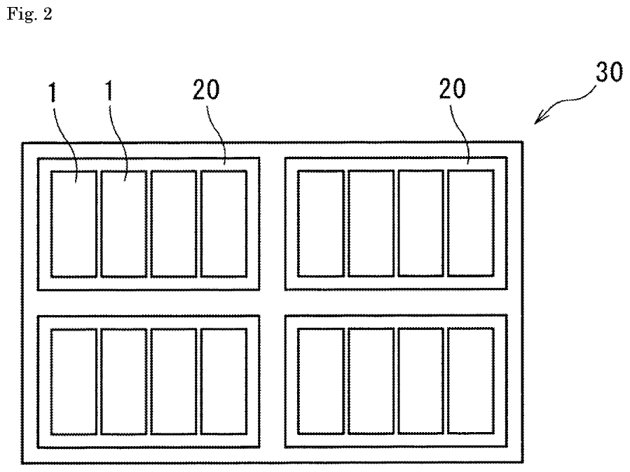

The present invention can also be realized as an energy storage apparatus including a plurality of the nonaqueous electrolyte energy storage devices. FIG. 2 shows one embodiment of the energy storage apparatus according to one embodiment of the present invention. In FIG. 2, an energy storage apparatus 30 includes a plurality of energy storage units 20. Each of the energy storage units 20 includes a plurality of the nonaqueous electrolyte energy storage devices 1. At least one of the nonaqueous electrolyte energy storage devices 1 included in the energy storage apparatus 30 may be the nonaqueous electrolyte energy storage device according to one embodiment of the present invention, may include one nonaqueous electrolyte energy storage device according to one embodiment of the present invention, and may include one or more nonaqueous electrolyte energy storage devices not according to one embodiment of the present invention, or two or more nonaqueous electrolyte energy storage devices according to one embodiment of the present invention. The energy storage apparatus 30 can be mounted as a power source for an automobile such as an electric vehicle (EV), a plug-in hybrid vehicle (PHEV), or the like.

### Other Embodiments

The present invention is not limited to the above embodiments, and various modifications may be made without departing from the gist of the present invention. For example, a configuration according to one embodiment can additionally be provided with a configuration according to another embodiment, or a configuration according to one embodiment can partially be replaced with a configuration according to another embodiment or a well-known technique. Furthermore, a part of the configuration according to one embodiment can be removed. In addition, a well-known technique can be added to the configuration according to one embodiment.

In the above-described embodiments, an embodiment in which the nonaqueous electrolyte energy storage device is a nonaqueous electrolyte secondary battery has been mainly described, but the nonaqueous electrolyte energy storage device may he other nonaqueous electrolyte energy storage device. Examples of the other nonaqueous electrolyte energy storage device include capacitors (electric double layer capacitors and lithium ion capacitors).

### EXAMPLES

Hereinafter, the present invention will be described in more detail with reference to examples, but the present invention is not limited to the following examples.

### [No.1]

### (Preparation of Hydroxide Precursor)

In production of the positive active material for a nonaqueous electrolyte energy storage device, a hydroxide precursor (positive active material precursor) was produced using the reactive crystallization method. First, 315.4 g of nickel sulfate hexahydrate, 168.6 g of cobalt sulfate heptahydrate, and 530.4 g of manganese sulfate pentahydrate were weighed, and all dissolved in 4 L of ion-exchange water to prepare a 1.0 mol/dm³ aqueous sulfate solution in which the molar ratio of Ni:Co:Mn (X_{Ni}:X_{Co}:X_{Mn}) was 30:15:55. In addition, 1.045 g of aluminum sulfate octadecahydrate was weighed, and all dissolved in 0.4 L of ion-exchange water to prepare a 0.005 mol/dm³ aluminum sulfate aqueous solution. Next, 2 L of ion-exchange water was poured into a reaction tank having an internal volume of 5 L and an inner diameter of 170 mm, and bubbled with nitrogen gas for 30 minutes to remove oxygen contained in the ion-exchange water. The temperature of the reaction tank was set to 50° C. (±2° C.), and an arrangement was made so as to sufficiently generate a conviction flow in the reaction tank while the contents of the reaction tank was stirred at a rotation speed of 1500 rpm using a paddle impeller equipped with a stirring motor. Subsequently, the aqueous sulfate solution was added dropwise at a rate of 1.3 mL/min and the aluminum sulfate aqueous solution was added dropwise at a rate of 0.13 mL/min to the reaction tank from different nozzles spaced. apart by a distance of 50 mm or more and 100 mm or less for 50 hours. Here, during a period between the start and the end of dropwise addition, a mixed aqueous alkali solution including 4.0 mol/dm³ of sodium hydroxide, 1.25 mol/dm³ of ammonia, and 0.1 mol/dm³ of hydrazine was appropriately added dropwise to perform control so that the pH in the reaction tank was 10.20 (±0.1) on a constant basis, and a part of the reaction liquid was discharged by overflow to perform control so that the total amount of the reaction liquid was not more than 2 L on a constant basis. After the end of the dropwise addition, stirring in the reaction tank was further continued for 1 hour. After the stirring was stopped, the mixture was allowed to stand at room temperature for 12 hours or more. Next, hydroxide precursor particles generated in the reaction tank were separated using a suction filtration apparatus, washed with ion-exchange water to remove sodium ions deposited on the particles, and dried at 80° C. for 20 hours under normal pressure in an air atmosphere using an electric furnace. Thereafter, for equalizing the particle sizes, the particles were ground for several minutes in an automatic mortar made of agate. In this way, a hydroxide precursor in which the molar ratio of Ni:Co:Mn (X_{Ni}:X_{Co}:X_{Mn}) was 30:15:55, and the molar ratio of Al: (Ni, Co, Mn) (X₁:X_{Me}) was 0.1:100 was prepared.

### (Preparation of Positive Active Material)

Lithium hydroxide monohydrate was added to the obtained. hydroxide precursor, and using an automatic mortar made of agate, the mixture was adequately stirred to prepare a mixed powder in which the molar ratio of Li: (Ni, Co, Mn) (X_{Ni}:X_{Co}:X_{Mn}) was 120:100. The mixed powder was pellet-molded and then placed on an alumina boat, using a box-shaped electric furnace (model number: AMF 20), the temperature was raised from room temperature to 900° C. over 10 hours under normal pressure in an air atmosphere, and firing was performed at 900° C. for 4 hours. After the firing, the heater was turned off, and the alumina boat was allowed to cool naturally while being left to stand in the furnace. As a result, although the temperature of the furnace decreased to about 200° C. after 5 hours, the subsequent temperature decrease rate was slightly low. After a lapse of an entire day and night, the temperature of the furnace was confirmed to be 60° C. or lower, and the pellets were then taken out, and ground for several minutes with an automatic mortar made of agate for equalizing the particle sizes. In this way, a positive active material according to No. 1 was produced. The positive active material was particulate, a part of aluminum was solid-solved in the lithium transition metal composite oxide, and another part of aluminum was present on the surface of the particle of the lithium transition metal composite oxide.

### [No. 2 to No. 5]

Positive active materials according to No. 2 to No, 5 were produced similarly to No. 1, except that the amount of aluminum sulfate octadecahydrate was changed so that the molar ratio of Al: (Ni, Co, Mn) (X_{Al}:X_{Me}) was as shown in Table 1. These positive active materials were particulate, a part of aluminum was solid-solved in the lithium transition metal composite oxide, and another part of aluminum was present on the surface of the particle of the lithium transition metal composite oxide.

### [No. 6 to No. 9]

Positive active materials according to No. 6 to No. 9 were produced similarly to No. 5, except that the amounts of nickel sulfate hexahydrate, cobalt sulfate heptahydrate, and manganese sulfate pentahydrate were changed so that the molar ratio of Ni:Co:Mn (X_{Ni}:X_{Co}:X_{Mn}) was as shown in Table 1. These positive active materials were particulate, a part of aluminum was solid-solved in the lithium transition metal composite oxide, and another part of aluminum was present on the surface of the particle of the lithium transition metal composite oxide.

### [No. 10, No. 11]

Positive active materials according to No. 10 and No. 11 were produced similarly to No. 5, except that the amounts of nickel sulfate hexahydrate, cobalt sulfate heptahydrate, and manganese sulfate pentahydrate were changed so that the molar ratio of Ni:Co:Mn (X_{Ni}:X_{Co}:X_{Mn}) was as shown in Table 1, and a mixed powder was prepared so that the molar ratio of Li:(Ni, Co, Mn) (X_{Li}:X_{Me}) was 100:100. These positive active materials were particulate, a part of aluminum was solid-solved in the lithium transition metal composite oxide, and another part of aluminum was present on the surface of the particle of the lithium transition metal composite oxide.

### [No.12]

A positive active material according to No. 12 was produced similarly to No. 5, except that the amounts of nickel sulfate hexahydrate, cobalt sulfate heptahydrate, and manganese sulfate pentahydrate were changed so that the molar ratio of Ni:Co:Mn (X_{Ni}:X_{Co}:X_{Mn}) was 20:12.5:67.5, and a mixed powder was prepared so that the molar ratio of Li:(Ni, Co, Mn) (X_{Li}:X_{Me}) was 140:100. The positive active material was particulate, a part of aluminum was solid-solved in the lithium transition metal composite oxide, and another part of aluminum was present on the surface of the particle of the lithium transition metal composite oxide.

### [No.13]

A lithium transition metal composite oxide was prepared similarly to No. 1 except that the aluminum sulfate aqueous solution was not added dropwise during the preparation of the hydroxide precursor. This lithium transition metal composite oxide was used as the positive active material according to No. 13.

### [No.14]

First, a lithium transition metal composite oxide was prepared similarly to No. 1 except that the aluminum sulfate aqueous solution was not added dropwise. The temperature of an aqueous solution obtained by dissolving aluminum citrate in 200 mL of ion-exchange water was maintained at 50° C. so that the concentration was 5.15×1.0⁻³ mol/dm³, a an aqueous citric acid solution was added so as to have a pH of 2.75 to prepare an aqueous aluminum citrate solution. 5.0 g of the lithium transition metal composite oxide was immersed in the aluminum citrate aqueous solution, stirred at 600 rpm for 1 minute using a stirrer, and then adjusted so that the pH was 7.0 to 7.5. At that time, when the pH was lower than a target value, an aqueous ammonia solution was added, and when the pH was higher than the target value, an aqueous citric acid solution was added. After adjusting the pH, the mixture was further stirred for 5 minutes to precipitate an Al-containing material on the surface of the lithium transition metal composite oxide. Next, lithium transition metal composite oxide particles were separated using a suction filtration device, and dried overnight at 80° C. under an air atmosphere at normal pressure. A lithium transition metal composite oxide powder after the drying was placed on an alumina boat, using a box-shaped electric furnace (model number: AMF 20), the temperature was raised. from room temperature to 400° C. at 5° C/min under normal pressure in an air atmosphere, and firing was performed at 400° C. for 8 hours. After the firing, the heater was turned off, and the alumina boat was allowed to cool naturally while being left to stand in the furnace. The temperature of the furnace was confirmed to be 50° C. or lower, and the pellets were then taken out, and ground for several minutes with an automatic mortar made of agate for equalizing the particle sizes. In this way, a positive active material according to No. 14 was produced. In this positive active material, the surfaces of the particles of the lithium transition metal composite oxide were substantially uniformly coated with aluminum oxide.

### [No.15]

A hydroxide precursor was prepared using the reactive crystallization method. First, 315.4 g of nickel sulfate hexahydrate, 168.6 g of cobalt sulfate heptahydrate, 530.4 g of manganese sulfate pentahydrate, and 20.89 g of aluminum sulfate octadecahydrate were weighed, and all dissolved in 4 L of ion-exchange water to prepare a 1.0 mol/dm³ aqueous sulfate solution in which the molar ratio of Ni:Co:Mn (X_{Ni}:X_{Co}:X_{Mn}) was 30:15:55 and the molar ratio of Al:(Ni, Co, Mn) (X_{Al}:X_{Me}) was 2:100. Next, 2 L of ion-exchange water was poured into a 5 L reaction tank, and bubbled with nitrogen gas for 30 minutes to remove oxygen contained in the ion-exchange water. The temperature of the reaction tank was set to 50° C. (±2° C.), and an arrangement was made so as to sufficiently generate a conviction flow in the reaction tank while the contents of the reaction tank was stirred at a rotation speed of 1500 rpm using a paddle impeller equipped with a stirring motor. Subsequently, the aqueous sulfate solution was added dropwise to the reaction tank at a rate of 1.3 mL/min for 50 hours. Here, during a period between the start and the end of dropwise addition, a mixed aqueous alkali solution including 4.0 mol/dm³ of sodium hydroxide, 1.25 mol/dm³ of ammonia, and 0.1 mol/dm³ of hydrazine was appropriately added dropwise to perform control so that the pH in the reaction tank was 10.20 (±0.1) on a constant basis, and a part of the reaction liquid was discharged by overflow to perform control so that the total amount of the reaction liquid was not more than 2 L on a constant basis. After the end of the dropwise addition, stirring in the reaction tank was further continued for 1 hour. After the stirring was stopped, the mixture was allowed to stand at room temperature for 12 hours or more. The subsequent procedure was performed exactly similarly to No. 1 to produce a positive active material according to No. 15. In this positive active material, aluminum was completely solid-solved in the lithium transition metal composite oxide.

### [No. 16, No. 19]

Positive active materials according to No. 16 and No. 19 were produced similarly to No. 13, except that the amounts of nickel sulfate hexahydrate, cobalt sulfate heptahydrate, and manganese sulfate pentahydrate were changed so that the molar ratio of Ni:Co:Mn (X_{Ni}:X_{Co}:X_{Mn}) was as shown in Table 1, and a mixed powder was prepared so that the molar ratio of Li:(Ni, Co, Mn) (X_{Li}:X_{Me}) was 100:100.

### [No. 17 No. 20]

Positive active materials according to No. 17 and No. 20 were produced similarly to No. 14, except that the amounts of nickel sulfate hexahydrate, cobalt sulfate heptahydrate, and manganese sulfate pentahydrate were changed so that the molar ratio of Ni:Co:Mn (X_{Ni}:X_{Co}:X_{Mn}) was as shown in Table 1, and a mixed powder was prepared so that the molar ratio of Li:(Ni, Co, Mn) (X_{Li}:X_{Me}) was 100:100. In these positive active materials, the surfaces of the particles of the lithium transition metal composite oxide were substantially uniformly coated with aluminum oxide.

### [No. 18, No. 21]

Positive active materials according to No. 18 and No. 21 were produced similarly to No. 15, except that the amounts of nickel sulfate hexahydrate, cobalt sulfate heptahydrate, and manganese sulfate pentahydrate were changed so that the molar ratio of Ni:Co:Mn (X_{Ni}:X_{Co}:X_{Mn}) was as shown in Table 1, and a mixed powder was prepared so that the molar ratio of Li:(Ni, Co, Mn) (X_{Li}:X_{Me}) was 100:100. In these positive active materials, aluminum was completely solid-solved in the lithium transition metal composite oxide.

### [No.22]

A lithium transition metal composite oxide was prepared similarly to No. 12 except that the aluminum sulfate aqueous solution was not added dropwise during the preparation of the hydroxide precursor. This lithium transition metal composite oxide was used as the positive active material according to No. 22.

### <Fabrication of Positive Electrode>

For the positive active materials according to No. 1 to No. 22, a positive composite paste was produced, which contained a positive active material, acetylene black (AB), and polyvinylidene fluoride (PVDF) at a mass ratio of 90:5:5 (in terms of solid content) with N-methylpyrrolidone (NMP) as a dispersion medium. This positive composite paste was applied to an aluminum foil (thickness: 15 μm) as a positive electrode substrate, and dried to obtain a positive electrode.

### <Fabrication of Negative Electrode>

A negative composite paste was produced, which contained graphite as a negative active material, styrene butadiene rubber (SBR), and carboxymethyl cellulose (CMC) at a mass ratio of 96:3.2:0.8 (in terms of solid content) with water as a dispersion medium. This negative composite paste was applied to a copper foil (thickness: 10 μm) as a negative electrode substrate, and dried to obtain a negative electrode.

### <Assembly of Test Battery>

For each of No. 1 to No. 22, a test battery (nonaqueous electrolyte energy storage device) using the positive electrode and the negative electrode was assembled. As a nonaqueous electrolyte, a solution obtained by dissolving lithium hexafluorophosphate (LiPF₆) as an electrolyte salt in a nonaqueous solvent obtained by mixing EC (ethylene carbonate), EMC (ethylmethyl carbonate), and dimethyl carbonate (DMC) at a volume ratio of 30:35:35 so that the content of the lithium hexafluorophosphate was 1.0 mol/dm³ was used, and a polyolefin macroporous membrane was used as a separator.

### <Initial Charge-Discharge>

The obtained nonaqueous electrolyte energy storage device (uncharged and undischarged nonaqueous electrolyte energy storage device) before initial charge-discharge was subjected to initial charge-discharge at 25° C. in the following manner. Constant current constant voltage charge was performed at a charge current of 0.1 C and an end-of-charge voltage of 4.25 V (positive electrode achieved. potential: 4.35 V vs. Li/Li⁺). An end-of-charge condition was set at a time point at which the current value decreased to 0.02 C. Thereafter, constant current discharge was performed at a discharge current of 0.1 C and an end-of-discharge voltage of 2.5 V.

### <Oxygen Position Parameter>

For the battery after the initial charge-discharge test, the oxygen positional parameter was measured by adopting the above procedure and conditions. The value of the obtained oxygen positional parameter (zO1) is shown in Table 1.

In addition, with respect to the oxygen positional parameter (zO1) of the positive active materials according to No. 1 to No. 5, No. 10 to No. 12, No. 14, No. 15, No. 17 No. 18, No. 20, and No. 21, a difference from the oxygen positional parameter (zO2) measured under the same condition for a positive active material which contains no aluminum and has the same composition in terms of a molar ratio of a transition metal element contained was determined. As the oxygen positional parameter (zO2), oxygen positional parameters of No. 13, No. 16, No. 19, and No. 22 were used. The calculation results are shown in Table 1.

### <High Rate Discharge Performance Test>

For each nonaqueous electrolyte energy storage device after the initial charge-discharge test, a high rate discharge performance test was performed by performing a total of two cycles of charge-discharge at 25° C. in the following manner. Charge was constant current constant voltage charge with a charge current of 1.0 C and an end-of-charge voltage of 4.25 V (positive electrode achieved potential: 4.35 V vs. Li/Li⁺), and the end-of-charge condition was set at a time point at which the current value decreased to 0.05 C. Discharge was constant current discharge with an end-of-discharge voltage of 2.5 V. The discharge current was 0.1 C in the first cycle and 5.0 C in the second cycle. A rest period of 10 minutes was provided after each of charge and discharge. A ratio of the 5.0 C discharge capacity to the 0.1 C discharge capacity (5 C/0.1 C discharge capacity ratio) in this charge-discharge test was calculated. The results are shown in Table 1.

### <Charge-Discharge Cycle Capacity Retention Ratio>

Each nonaqueous electrolyte energy storage device after the initial charge-discharge test was subjected to a charge-discharge cycle test at 45° C. in the following manner. Constant current constant voltage charge was performed at a charge current of 1.0 C and an end-of-charge voltage of 4.25 V (positive electrode achieved potential: 4.35 V vs. Li/Li⁺). The end-of-charge condition was set at a time point at which the current value decreased to 0.05 C. Thereafter, constant current discharge was performed at a discharge current of 1.0 C and an end-of-discharge voltage of 2.5 V. A rest period of 10 minutes was provided after each of charge and discharge. This charge-discharge was performed 100 cycles. A ratio of the discharge capacity after 100 cycles to the discharge capacity after two cycles in this charge-discharge cycle test was obtained as the charge-discharge cycle capacity retention ratio [%]. The calculation results are shown in Table 1.

TABLE 1

| | | | | | | Physical property | | Evaluation | |
|---|---|---|---|---|---|---|---|---|---|
| | | | | | | | Difference | Cycle | 5 C/0.1 C |
| Nonaqueous | Molar ratio of each metal element to total | | | | | Oxygen | in oxygen | capacity | discharge |
| electrolyte | content of transition metal element in | | | | | positional | positional | retention | capacity |
| energy-storage | lithium transition metal composite oxide | | | | | parameter | parameters | ratio | ratio |
| device | Li | Ni | Co | Mn | Al | (zO1) | (zO1 − zO2) | [%] | [%] |
| No. 1 | 1.2 | 0.30 | 0.15 | 0.55 | 0.1 | 0.269 | 0.002 | 92 | 81 |
| No. 2 | 1.2 | 0.30 | 0.15 | 0.55 | 0.5 | 0.268 | 0.001 | 93 | 81 |
| No. 3 | 1.2 | 0.30 | 0.15 | 0.55 | 1.0 | 0.267 | 0.000 | 93 | 81 |
| No. 4 | 1.2 | 0.30 | 0.15 | 0.55 | 1.5 | 0.266 | −0.001 | 93 | 80 |
| No. 5 | 1.2 | 0.30 | 0.15 | 0.55 | 2.0 | 0.265 | −0.002 | 93 | 80 |
| No. 6 | 1.2 | 0.35 | 0.15 | 0.50 | 2.0 | 0.265 | — | 93 | 81 |
| No. 7 | 1.2 | 0.40 | 0.15 | 0.45 | 2.0 | 0.265 | — | 92 | 81 |
| No. 8 | 1.2 | 0.45 | 0.15 | 0.40 | 2.0 | 0.265 | — | 92 | 82 |
| No. 9 | 1.2 | 0.50 | 0.15 | 0.35 | 2.0 | 0.265 | — | 92 | 82 |
| No. 10 | 1.0 | 0.33 | 0.33 | 0.33 | 2.0 | 0.267 | 0.000 | 91 | 83 |
| No. 11 | 1.0 | 0.50 | 0.20 | 0.30 | 2.0 | 0.267 | 0.000 | 91 | 83 |
| No. 12 | 1.4 | 0.20 | 0.125 | 0.675 | 2.0 | 0.264 | 0.000 | 84 | 81 |
| No. 13 | 1.2 | 0.30 | 0.15 | 0.55 | 0.0 | 0.267 | — | 83 | 81 |
| No. 14 | 1.2 | 0.30 | 0.15 | 0.55 | 2.0 | 0.270 | 0.003 | 93 | 75 |
| No. 15 | 1.2 | 0.30 | 0.15 | 0.55 | 2.0 | 0.264 | −0.003 | 87 | 80 |
| No. 16 | 1.0 | 0.33 | 0.33 | 0.33 | 0.0 | 0.267 | — | 82 | 82 |
| No. 17 | 1.0 | 0.33 | 0.33 | 0.33 | 2.0 | 0.270 | 0.003 | 91 | 75 |
| No. 18 | 1.0 | 0.33 | 0.33 | 0.33 | 2.0 | 0.264 | −0.003 | 85 | 80 |
| No. 19 | 1.0 | 0.50 | 0.20 | 0.30 | 0.0 | 0.267 | — | 82 | 82 |
| No. 20 | 1.0 | 0.50 | 0.20 | 0.30 | 2.0 | 0.270 | 0.003 | 91 | 75 |
| No. 21 | 1.0 | 0.50 | 0.20 | 0.30 | 2.0 | 0.264 | −0.003 | 85 | 80 |
| No. 22 | 1.4 | 0.20 | 0.125 | 0.675 | 0.0 | 0.264 | — | 80 | 81 |

As shown in Table 1, for the positive active material containing aluminum, No. 1 to No. 5 and No. 10 to No. 12 in which the absolute value of the difference in the oxygen positional parameter with respect to the positive active material which contains no aluminum and has the same composition in terms of the molar ratio of the transition metal element contained is 0.002 or less have excellent 5 C/0.1 C discharge capacity ratio and high charge-discharge cycle capacity retention ratio with respect to the positive active material containing aluminum in which the absolute value of the difference in the oxygen positional parameter exceeds 0.002.

As shown in Table 1, for the positive active material containing aluminum, the nonaqueous electrolyte energy storage devices according to No. 1 to No. 11 in which the oxygen positional parameter is 0.265 or more and 0.269 or less have excellent values in both the charge-discharge cycle capacity retention ratio and the 5 C/0.1 C discharge capacity ratio. Among them, the nonaqueous electrolyte energy storage devices according to No. 1 to No. 9 in which the lithium transition metal composite oxide having an X_{Mn}/X_{Me} of 0.34 or more and an X_{Li}/X_{Me} of more than 1.0 is used as the positive active material are excellent in charge-discharge cycle capacity retention ratio of 92% or more.

On the other hand, in the nonaqueous electrolyte energy storage devices according to No. 13, No. 16, No. 19, and No. 22 in which the positive active material does not contain aluminum, and No. 15, No. 18, and No. 21 in which the difference in oxygen positional parameter is −0.003, the charge-discharge cycle capacity retention ratio is a low value. In the nonaqueous electrolyte energy storage devices according to No. 14, No. 17, and No. 20 in which the difference in oxygen positional parameter is 0.003, the 5 C/0.1 C discharge capacity ratio is a low value.

### INDUSTRIAL APPLICABILITY

The present invention can be applied to a nonaqueous electrolyte energy storage device and the like used as a power source for electronic devices such as personal computers and communication terminals, automobiles, and industrial use and the like.

### DESCRIPTION OF REFERENCE SIGNS

1: nonaqueous electrolyte energy storage device

2: electrode assembly

3: case

4: positive electrode terminal

41: positive electrode lead

5: negative electrode terminal

51: negative electrode lead

20: energy storage unit

30: energy storage apparatus

1. A positive active material for a nonaqueous electrolyte energy storage device containing a lithium transition metal composite oxide having an α-NaFeO₂ structure, the positive active material for a nonaqueous electrolyte energy storage device further comprising aluminum,
wherein the lithium transition metal composite oxide contains at least one selected from the group consisting of nickel and cobalt, and manganese,
the positive active material satisfies at least one of the following conditions (1) or (2),
(1) a content of manganese in a transition metal in the lithium transition metal composite oxide is 0.6 or less in terms of molar ratio, and
in a charged state at a potential of 4.35 V vs. Li/Li⁺ in a state where there is no charge history in which the potential reaches 4.5 V vs. Li/Li⁺ or more, an oxygen positional parameter of the positive active material determined from crystal structure analysis by a Rietveld method when a space group R3-m is used for a crystal structure model based on an X-ray diffraction pattern is 0.265 or more and 0.269 or less,
(2) in a charged state at a potential of 4.35 V vs. Li/Li⁺ in a state where there is no charge history in which the potential reaches 4.5 V vs. Li/Li⁺ or more,
an absolute value of a difference between an oxygen positional parameter of the positive active material determined from crystal structure analysis by a Rietveld method when a space group R3-m is used for a crystal structure model based on an X-ray diffraction pattern and an oxygen positional parameter of a positive active material, which contains no aluminum and has the same composition as the positive active material in terms of a molar ratio of a transition metal element contained, determined from the crystal structure analysis is 0.002 or less.

2. (canceled)

3. The positive active material for a nonaqueous electrolyte energy storage device according to claim 1, wherein when the positive active material satisfies the condition (2), the content of manganese in the transition metal in the lithium transition metal composite oxide is 0.3 or more and 0.7 or less in terms of molar ratio.

4. The positive active material for a nonaqueous electrolyte energy storage device according to claim 1, wherein a ratio of the number of moles of lithium to the number of moles of transition metal in the lithium transition metal composite oxide is 1.0 or more and 1.4 or less.

5. The positive active material for a nonaqueous electrolyte energy storage device according to claim 1, wherein a ratio of the number of moles of aluminum to the number of moles of transition metal in the lithium transition metal composite oxide is 0.1 or more and 2 or less.

6. The positive active material for a nonaqueous electrolyte energy storage device according to claim 5 being a particle containing the lithium transition metal composite oxide, and a ratio of the number of moles of aluminum to a sum of the number of moles of transition metal and the number of moles of aluminum being larger in the vicinity of a surface of the particle than that in the vicinity of a center of the particle.

7. A positive electrode for a nonaqueous electrolyte energy storage device comprising the positive active material according to claim 1.

8. A nonaqueous electrolyte energy storage device comprising the positive electrode for a nonaqueous electrolyte energy storage device according to claim 7.

9. The nonaqueous electrolyte energy storage device according to claim 8, wherein a positive electrode potential at an end-of-charge voltage under normal usage is less than 4.5 V vs. Li/Li⁺.

10. An energy storage apparatus comprising:
a plurality of nonaqueous electrolyte energy storage devices; and
one or more of the nonaqueous electrolyte energy storage devices according to claim 8.

11. A method for using the nonaqueous electrolyte energy storage device according to claim 8, comprising charging at a positive electrode potential in a range of less than 4.5 V vs. Li/Li⁺.

12. A method for manufacturing the nonaqueous electrolyte energy storage device according to claim 8, comprising performing initial charge-discharge at a positive electrode potential in a range of less than 4.5 V vs. Li/Li⁺.
